(19) United States
(12) Patent Application Publication
(10) Pub. No.: US 2011/0191103 A1
(43) Pub. Date: Aug. 4, 2011

(54) PORTABLE TERMINAL TO ADJUST SOUND OUTPUT OF WIRELESS HEADSET

(75) Inventors: Sang-Woo SHIN, Incheon-si (KR); Nam-Young RYU, Goyang-si (KR); Wave OH, Seoul (KR); Jung-Hak CHOI, Seoul (KR); Man-Jung YI, Seoul (KR)

(73) Assignee: PANTECH CO., LTD., Seoul (KR)

(21) Appl. No.: 13/010,456

(22) Filed: Jan. 20, 2011

(30) Foreign Application Priority Data
Jan. 29, 2010 (KR) 10-2010-0008806

(51) Int. Cl. G10L 19/14

(52) U.S. Cl. 704/225; 704/E19.039

(57) ABSTRACT

A portable terminal and method for adjusting transmitted sound output to a wireless headset. A portable terminal includes a wireless connection setting unit to establish a connection with a wireless headset and a loopback control unit. The loopback control unit may transmit a test signal within a voice band to the connected wireless headset, receive a sound signal inputted through a microphone of the portable terminal in response to the transmitted test signal, analyze the received sound signal and adjust sound output to be transmitted to the wireless headset. A method for adjusting sound output includes establishing a connection with a wireless headset, transmitting a test signal within a voice band, receiving a sound signal inputted through a microphone of the portable terminal in response to the transmitted test signal, analyzing the sound signal, and adjusting sound output to be transmitted to the wireless headset according to the analysis result.

### CROSS-REFERENCE TO RELATED APPLICATION

This application claims priority from and the benefit under 35 U.S.C. §119(a) of Korean Patent Application No. 10-2010-0008806, filed on Jan. 29, 2010, which is herby incorporated by reference for all purposes as if fully set forth herein.

### BACKGROUND

1. Field

The following description relates to a portable electronic device, and more particularly, to an electronic device connected to a wireless headset and capable of conducting a voice call or playback of media contents.

2. Discussion of the Background

As a short-range communication technology, Bluetooth® has been widely adopted in portable electronic devices. A Bluetooth® headset connected to a mobile phone or a media playing device supports audio signal transmission or receipt through a hands-free or headset profile. Conventionally, Bluetooth® headsets have different default settings of volume and tone according to their manufacturer requirements, which may be readjusted to user's preferences each time a connection is made between a device and a different Bluetooth® headset. Thus, the constant need for adjustment causes an inconvenience to the users of Bluetooth® headsets.

### SUMMARY

Exemplary embodiments of the present invention provide a portable electronic device connected to a wireless headset and capable of controlling sound output to conduct a voice call or playback of media contents. Exemplary embodiments of the present invention also provide a method for controlling sound output of a portable terminal using a wireless headset.

Additional features of the invention will be set forth in the description which follows, and in part will be apparent from the description, or may be learned by practice of the invention.

Exemplary embodiments of the present invention provide portable terminal including a microphone, a wireless connection setting unit to establish a connection with a wireless headset, and a loopback control unit to transmit a test signal within a voice band to the wireless headset, to receive a sound signal input through the microphone in response to the transmitted test signal, and to adjust sound output to be transmitted to the headset by analyzing the sound signal.

Exemplary embodiments of the present invention provide a method for controlling sound output of a portable terminal using a wireless headset, including establishing a connection with a wireless headset, transmitting a test signal within a voice band to the connected wireless headset, receiving a sound signal inputted through a microphone of the portable terminal in response to the transmitted test signal, analyzing the sound signal, and adjusting sound output to be transmitted to the wireless headset according to the analysis result.

Exemplary embodiments of the present invention provide a portable terminal, including a program to execute a method for controlling sound output of a portable terminal using a wireless headset. The method includes establishing a connection with a wireless headset, transmitting a test signal within a voice band to the connected wireless headset, receiving a sound signal inputted through a microphone of the portable terminal in response to the test signal, analyzing the sound signal input, and adjusting sound output to be transmitted to the wireless headset according to the analysis result.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a configuration of a portable terminal according to an exemplary embodiment of the invention.

FIG. 2 is a flowchart illustrating a method for adjusting sound output through a wireless headset according to an exemplary embodiment of the invention.

FIG. 3 is an illustration of a test signal transmission from a test signal transmitting unit.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

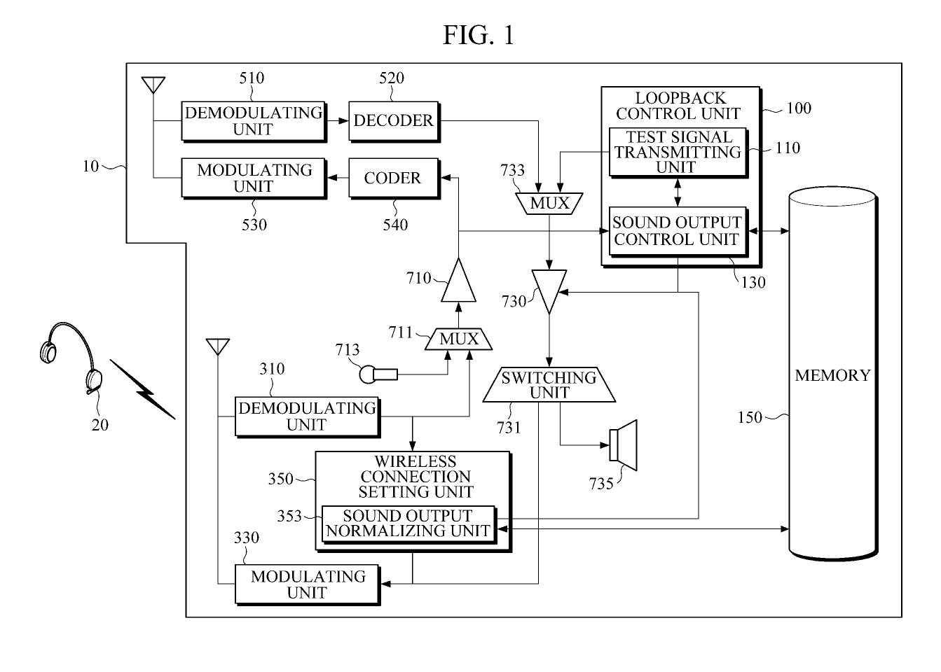

FIG. 1 is a schematic diagram illustrating a configuration of a portable terminal according to an exemplary embodiment of the invention. As shown in FIG. 1, a portable terminal 10 is connected to a wireless headset 20. The portable terminal 10 may be a mobile phone and the wireless headset 20 may be a Bluetooth® headset. A connection between the portable terminal 10 and the wireless headset 20 may be established according to a Bluetooth® headset profile. A Bluetooth® headset profile allows a host terminal to recognize multiple slave terminals and to connect automatically to a slave terminal that has been previously registered by a user. However, the wireless headset 20 is not limited to Bluetooth® technology, and may be another type of a wireless headset in accordance with a short-range communication method. Likewise, the portable terminal 10 is not limited to a mobile phone, and may be any other type of a portable device, such as an MP3 player or a portable multimedia player (PMP).

As shown further in FIG. 1, a portable terminal 10 includes a wireless connection setting unit 350 and a loopback control unit 100. In an example, the loopback control unit 100 may include a test signal transmitting unit 110 and a sound output control unit 130. Initially, wireless connection setting unit 350 recognizes a wireless headset 20 and establishes a connection with the recognized wireless headset 20. Once a connection has been made, test signal transmitting unit 110 transmits a test signal within a voice band to the wireless headset 20. In an example, the test signal transmitted by test signal transmitting unit 110 may be a tone signal within a voice band. In response to the transmitted test signal, the sound output control unit 130 receives a sound signal that is inputted through the microphone 713, and then converts the received sound signal into a digital signal. After the conversion, a comparison is made between the converted digital signal and the sound output reference data. Based on the comparison result, the sound output control unit 130 controls a gain value of a sound output amplifier 730. If there are multiple frequencies included in the test signal and sound signal, a sound output amplifier 710 may function as an equalizer that can set a gain value of each frequency band included in the test signal or sound signal.

As an example, if a connection with a wireless headset 20 is established for the first time after the registration of the wireless headset 20, a gain value for the wireless headset 20 may be initialized if no gain value has been previously set. Once a gain value has been established through the process described above for the wireless headset 20, a sound output control unit 130 stores the optimal gain value in a pre-set terminal information table of the memory 150. If a connection with the same wireless headset 20 is established later, the sound output normalizing unit 353 searches for the pre-set terminal information table of the memory 150 for a corresponding wireless headset to determine whether the wireless headset 20 has a pre-established optimal gain value. Once the wireless headset 20 is determined as a pre-set wireless headset, the sound output normalizing unit 353 reads the gain value from the pre-set terminal information table of the memory 150 and outputs the retrieved gain value as a gain value of the sound output amplifier 730.

In an example, a user turns on a wireless headset 20, establishes a connection with a portable terminal 10. In response to the establishment of a connection with the wireless headset 20, the inner controller (not shown) may control a multiplexer 733, switching unit 731, and multiplexer 711 to select an output from a decoder 520, multiplexer 733, and demodulating unit 310, respectively. As a result, listening to a voice call or media through the wireless headset is feasible.

More specifically, the inner controller may control the multiplexer 733 to select the output of a test signal transmitting unit 110 in response to the user's selection of a sound adjustment function. In addition, the inner controller may control the switching unit 731 to select the output of a wireless module side, including the demodulating unit 310 and the modulating unit 330. Also, the inner controller may also control the multiplexer 711 to select an output from the microphone 713.

In an example, if a sound adjustment function is selected from menus of the portable terminal 10, a test signal may be transmitted to the wireless headset 20. Once the test signal has been transmitted in response to selecting the sound adjustment function on the portable terminal 10, the multiplexer 733 may select the test signal output from the test signal transmitting unit 110. Then, the user may place a speaker of the wireless headset 20 close to the microphone 713 (i.e. 1 cm apart from the microphone 713), and press a button on the portable terminal 10 or speak a command to begin the test. The portable terminal 10 may start adjusting transmission sound settings in response. The adjusting process may be executed by an inner circuit of the portable terminal 10, which estimates and normalizes the intensity and characteristics of a sound output to be sent to the wireless headset 20 based on the sound signal received from the microphone 713.

In an example, adjustment process may be initiated by an inner controller via a test signal transmitting unit 110 transmitting a test signal within a voice band to a connected wireless headset 20. In response, a sound output control unit 130 receives a sound signal that is inputted from the microphone 713 of the portable terminal 10. Then the sound output control unit 130 converts the received sound signal into a digital signal, compares the converted digital signal with sound output reference data, and controls a gain value of a sound output amplifier 730 based on the comparison result.

As shown in FIG. 1, a portable terminal 10 includes a modem part including a modulating unit 530, a demodulating unit 510, and a codec including a decoder 520 and a coder 540. In addition, the portable terminal 10 further includes a short-range communication baseband modem including a demodulating unit 310 and a modulating unit 330 for short-range communication. Moreover, the portable terminal 10 also includes a wireless connection setting unit 350 to recognize and register a slave terminal and establish a wireless connection with the registered slave terminal.

In an example, a multiplexer 733 selectively outputs either the test signal transmitted from a test signal transmitting unit 110 or the received sound signal output from a decoder 520 under the control of an inner controller of a portable terminal 10. Once the test signal has been transmitted in response to selecting the sound adjustment function on the portable terminal 10, the multiplexer 733 selects the test signal output from the test signal transmitting unit 110. Then, the sound signal or test signal output from a multiplexer 733 is amplified by a sound output amplifier 730. The amplified signal is selectively outputted to either a modulating unit 330 or a speaker 735 by a switching unit 731 under the control of the inner controller. In response to establishing a connection with the wireless headset 20, the switching unit 731 is switched to output the amplified signal to the modulating unit 330.

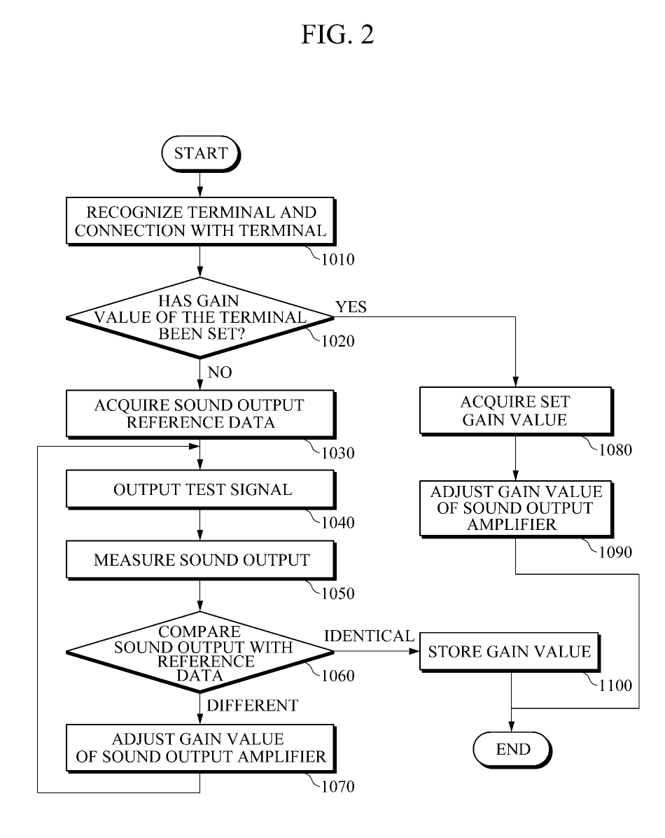

FIG. 2 is a flowchart illustrating a method for adjusting sound output through a wireless headset according to an exemplary embodiment of the invention. The example illustrated in FIG. 2 may be implemented as a program to be executed by an inner controller of a portable terminal 10.

As shown in FIG. 2, a method for adjusting a sound output of a portable terminal 10 may include a wireless connection establishing process (1010) and a loopback adjustment process (1020 to 1100). In operation 1010, a wireless headset is recognized and a connection with the recognized wireless headset is established. Subsequently, in the loopback adjustment process, a test signal within a voice band is transmitted to the connected wireless headset. In response to the transmitted test signal, a sound signal is inputted through a microphone of the portable terminal and analyzed. Lastly, the sound output to be transmitted to the wireless headset is adjusted based on the analysis result.

In an example, the wireless connection setting unit 350 of a portable terminal 10, recognizes a wireless headset 20 according to a wireless headset profile. If the identified wireless headset 20 has not been yet registered, registration process is preceded by the user's manipulation of the portable terminal 10. Once registered, the connection between the portable terminal 10 and the wireless headset 20 may be established (1010).

Once the connection between the portable terminal 10 and the wireless headset 20 is established (1010), a check is conducted to determine whether a gain value of the sound output amplifier 730 is set with respect to the recognized wireless headset 20 (1020). If it is determined that the gain value has not yet been set, the process seeks to acquire a sound output reference data (1030 to 1070). Alternatively, if it is determined that the gain value has been set previously, a sound output control unit 130 acquires the sound output reference data which has been stored in the memory 150 (1030). In an example, if the sound signal with an appropriate intensity is outputted from a wireless headset 20 in response to the receipt of the test signal with a reference intensity of 1 KHz from the portable terminal 10, sound output reference data may be equivalent to the intensity of a sound signal received from the microphone 713. Reference intensity of 1 KHz is provided only as an example and is not limited to 1 KHz as various different reference intensities may be used.

Once sound output reference data has been acquired (1030), then, the test signal transmitting unit 110 generates a tone signal (i.e. 1 KHz) and outputs the tone signal as a test signal through the multiplexer 733 (1040). The test signal is amplified by the sound output amplifier 730 and transmitted to the wireless headset 20 through the modulating unit 330. The wireless headset 20 receives the test signal and outputs it to an inner speaker.

In an example, the loopback adjustment process includes a test signal transmitting process (1040) and an output sound adjustment process (1050 to 1070). In the test signal transmitting process, a test signal within a voice band is transmitted to the wireless headset. In the output sound adjustment process, a sound signal that has been outputted in response to the transmitted test signal is inputted through the microphone and converted into a digital signal (1050). The converted digital signal is then compared with sound output reference data (1060), and then a gain value of a sound output amplifier is controlled according to the comparison result (1070).

In an example of operation 1050, the speaker of the wireless headset 20 is placed at a predetermined distance (i.e. 1 cm), apart from the microphone 713. Then, microphone 713 receives a sound output from the wireless headset 20, which is converted into a digital signal by the internal circuitry of the portable terminal 10. The converted signal is subsequently inputted into the sound output control unit 130 via both multiplexer 711 and amplifier 710 in a sequential manner. The sound output control unit 130 may detect the level of the inputted signal using a finite impulse response (FIR) filter having a plurality of tabs.

In operation 1060, the sound output control unit 130 compares the detected output values with the sound output reference data acquired from the memory in operation 1030. If the comparison result shows that a difference between the output values and the sound output reference data is greater than a preset threshold, then the output values from the wireless headset 20 may be determined as too large or too small, and a gain value of the sound output amplifier 730 may be increased or decreased according to the determination result (1070). The changes made in the gain value may vary depending on the difference between the level value and the sound output reference data, thereby achieving more effective convergence speed. The threshold for the difference may be obtained experimentally.

The process to identify the gain value may be finished when the difference between the detected level value and the sound output reference data becomes zero or smaller than a predetermined threshold. Until this threshold value is reached, operations 1040 to 1060 may be repeated. A gain value, at the time when the difference reaches the threshold may be determined as the optimal value for generating the appropriate sound output to the wireless headset 20.

As an example, the gain values determined as final values of the sound output amplifier 730 (1070) are stored as setting values in a non-volatile memory 150 (1100). Once the connection between the portable terminal 10 and the wireless headset 20 is established (1010), a check is conducted to verify whether a gain value of the sound output amplifier 730 has been previously set for the recognized wireless headset 20 (1020). This check may be conducted by a sound output normalizing unit 353 residing within the wireless connection setting unit 350. If it is determined that a gain value has been previously set, the respective gain value is read as a setting value (1080) and configured as the gain value of the sound output amplifier 730 (1090).

Accordingly, if a connection with a wireless headset is established for the first time after the registration of the wireless headset, operations 1030 to 1100 are performed as no gain value would have been set. Once the initial process has been executed, a sound output control unit 130 stores the optimal gain value in a pre-set terminal information table of the memory 150. If a connection with the same wireless headset is established later, the sound output normalizing unit 353 searches the pre-set terminal information table of the memory 150 for a unique identifier number of the corresponding wireless headset to determine whether the wireless headset is a wireless headset for which the optimal gain value has been already set (1020). Once the wireless headset 20 is determined as a wireless headset for which the optimal gain value has been already set, the sound output normalizing unit 353 reads the gain value from the pre-set terminal information table of the memory 150 (1080). The sound output normalizing unit 353 outputs the retrieved gain value as a gain value of the sound output amplifier 730 (1090).

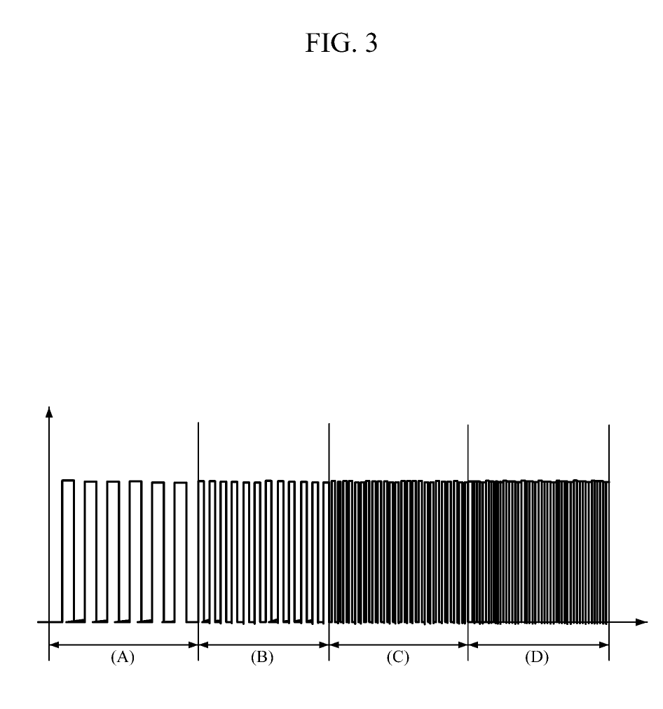

FIG. 3 is an illustration of a test signal transmission from a test signal transmitting unit 110 according to an exemplary embodiment of the invention. As an example, section A illustrates a 500-Hz tone signal, section B illustrates a 1-KHz tone signal, section C illustrates a 2-KHz tone signal, and section D illustrates a 3-KHz tone signal. Although not illustrated, a start bit pattern and a stop bit pattern may be added at each end of the series of test signals to inform of the start and the end of the test signal.

As an example, a loopback control unit 100 includes a test signal transmitting unit 110 and a sound output control unit 130. The test signal transmitting unit 110 may transmit test signals having different frequencies within a voice band sequentially to a wireless headset 20. The sound output control unit 130 may convert received sound signals into digital signals sequentially where the sound signals are received through a microphone 713 in response to the transmission of the test signals. Then, the sound output control unit 130 may compare the digital signals sequentially with the sound output reference data of each frequency, and control the gain values of each frequency band of the sound output amplifier 730 according to the comparison result. The sound output amplifier 710 may function as an equalizer that can set a gain value of each frequency band. The sound output amplifier 710 may be implemented as band filter amplifiers having the frequencies included in the signal shown in FIG. 3 as passbands.

As an example, sound output control unit 130 may recognize a start bit pattern of a test signal, and detect a level of the sound signal of each section that is inputted through the microphone 713 using a finite impulse response (FIR) filter. In a pre-set terminal information table of the memory 150, optimal gain values for each frequency are stored as sound output reference data. The sound output value measured at each section is compared with the sound output reference data of each frequency that is read from memory 150. According to the result of comparison for each frequency, equalizer gain values of the sound output amplifier 710 are adjusted. The operations of the sound output control unit 130 in this example are similar to the operations as illustrated in the flowchart of FIG. 2 with the exception that the reference data and a test signal are varied at each operation, and operations 1040 to 1070 may be repeated until a desired result is achieved for every frequency band included in the test signals or until stopped by a user or upon another condition, such as low battery power.

As an example, a loopback control unit 100 may include a test signal transmitting unit 110 and a sound output control unit 130. The test signal transmitting unit 110 may initially transmit a test signal within a voice band to a wireless headset 20. In response to the transmission of the test signals, sound signals are inputted through a microphone 713. Then, the sound output control unit 130 may convert sound signals into digital signals, obtain an amplitude value of each frequency by Fourier-transforming the converted digital signals, and compare sequentially the amplitude values with sound output reference data. As a result, the sound output control unit 130 may control a gain value of each frequency band of the sound output amplifier 730 according to the comparison result. Accordingly, the sound output amplifier 710 may function as an equalizer that is capable of setting a gain value of each frequency band included in the test signals. The sound output amplifier 710 may be implemented as band-filter amplifiers having different frequencies as their passbands.

A test signal outputted from the test signal transmitting unit 110 may be a voice-band signal. In a pre-set terminal information table of the memory 150, gain values of each frequency band of a signal are stored as sound output reference data of each frequency. The respective gain values can be measured by the sound output amplifier 710 when the voice-band signal from the test signal transmitting unit 110 is outputted through a wireless headset, which has been set to produce optimal sound quality and volume. The test signal may have a start bit pattern and a stop bit pattern added to both ends to indicate the start and end of the test signal.

The sound output control unit 130 may recognize a start bit pattern of the test signal and initialize measurement. In an example, a sound signal inputted through the microphone 713 may be, Fourier-transformed to acquire gain values of each frequency band of the sound signal. However, the transformation is not limited to digital or analog Fourier-transformation. Various frequency band gain calculation methods, including different bandpass filters that can calculate feature values of each frequency band, may be used. A FIR filter that can calculate a gain value of each frequency band may also be employed for transformation.

The sound output value measured for each section is compared with the sound output reference data of each frequency read from the memory 150. According to the comparison result, the equalizer gain values of the sound output amplifier 710 are adjusted. The operations of the sound output control unit 130 in the example are similar to the operations as illustrated in the flowchart of FIG. 2 except that the reference data and a test signal are varied at each operation, and operations 1040 to 1070 may be repeated until a desired result is achieved for every frequency band included in the test signals or until stopped by a user or upon another condition, such as low battery power.

As illustrated in the above examples, it is possible to normalize transmission characteristics of a terminal for individual wireless headsets without an additional device. In addition, it is possible to normalize sound quality as well as sound volume regardless of the type of a wireless headset. Furthermore, when a connection with a wireless headset for which normalization has been performed before it is established, normalization can be performed using setting values stored in a non-volatile memory without the need for a test signal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A portable terminal, comprising:
a microphone;
a wireless connection setting unit to establish a connection with a wireless headset; and
a loopback control unit to transmit a test signal within a voice band to the wireless headset, to receive a sound signal inputted through the microphone in response to the transmitted test signal, and to adjust sound output to be transmitted to the headset by analyzing the sound signal.

2. The portable terminal of claim 1, wherein the loopback control unit comprises:
a test signal transmitting unit to transmit the test signal within the voice band to the wireless headset; and
a sound output control unit to receive the sound signal inputted through the microphone in response to the transmitted test signal, to convert the sound signal into a digital signal, to compare the digital signal with sound output reference data, and to control a gain value of a sound output amplifier according to the comparison result.

3. The portable terminal of claim 1, wherein the loopback control unit comprises:
a test signal transmitting unit to transmit a plurality of test signals having different frequencies within the voice band to the wireless headset; and
a sound output control unit to receive sound signals inputted through the microphone in response to the test signals, to convert the received sound signals into digital signals, to compare the digital signals with sound output reference data, and to control a gain value of a first frequency band of a sound output amplifier according to the comparison result.

4. The portable terminal of claim 1, wherein the loopback control unit comprises:
a test signal transmitting unit to transmit the test signal within the voice band to the wireless headset; and
a sound output control unit to receive sound signals inputted through the microphone in response to the test signal, to convert the sound signals into digital signals, to obtain amplitude values of each frequency by Fourier-transforming the digital signals, to compare the amplitude values with sound output reference data of a first frequency, and to control a gain value of the first frequency of a sound output amplifier.

5. The portable terminal of claim 2, wherein the sound output control unit stores the gain value of the sound output amplifier as a setting value in a non-volatile memory.

6. The portable terminal of claim 5, wherein the wireless connection setting unit further comprises:
a sound output normalizing unit to confirm whether a gain value of the sound output amplifier has been previously set as a setting value with respect to the wireless headset, and, if the gain value has been previously set, to retrieve the stored setting value from the non-volatile memory and to configure the setting value as the gain value of the sound output amplifier.

7. A method for controlling sound output of a portable terminal using a wireless headset, comprising:
establishing a connection with a wireless headset;
transmitting a test signal within a voice band to the connected wireless headset;
receiving a sound signal inputted through a microphone of the portable terminal in response to the transmitted test signal;
analyzing the sound signal; and
adjusting sound output to be transmitted to the wireless headset according to the analysis result.

8. The method of claim 7, wherein analyzing the sound signal comprises:
converting the sound signal into a digital signal;
comparing the digital signal with sound output reference data; and
controlling a gain value of a sound output amplifier according to the comparison result.

9. The method of claim 7, wherein the test signal comprises a plurality of test signals having different frequencies within a voice band, the sound signal comprises a plurality of sound signals in response to the plurality of test signals having different frequencies, and analyzing the sound signal further comprises;
converting the sound signals into digital signals;
comparing the digital signals with sound output reference data of a first frequency band; and
controlling a gain value of the first frequency band of a sound output amplifier according to the comparison result.

10. The method of claim 7, wherein analyzing the sound signal comprises:
converting the sound signal into a digital signal;
acquiring an amplitude value of a frequency band by Fourier-transforming the digital signal;
comparing the amplitude value with sound output reference data of the frequency band; and
controlling a gain value of the frequency band of a sound output amplifier according to the comparison result.

11. The method of claim 7, wherein analyzing the sound signal comprises storing a gain value of a sound output amplifier as a setting value in a non-volatile memory.

12. The method of claim 11, further comprising:
determining whether a gain value of the sound output amplifier has been set with respect to the wireless headset; and
if the gain value has been set, retrieving the stored setting value from the non-volatile memory and configuring the setting value as the gain value of the sound output amplifier.

13. A portable terminal comprising:
a program to execute a method for controlling sound output of a portable terminal using a wireless headset, the method comprising:
establishing a connection with a wireless headset;
transmitting a test signal within a voice band to the connected wireless headset;
receiving a sound signal inputted through a microphone of the portable terminal in response to the test signal;
analyzing the sound signal input; and
adjusting sound output to be transmitted to the wireless headset according to the analysis result.

14. The portable terminal of claim 13, wherein the method further comprises storing a gain value of a sound output amplifier as a setting value in a non-volatile memory.

15. The portable terminal of claim 14, wherein the method further comprises:
determining whether a gain value of the sound output amplifier has been previously set with respect to the wireless headset; and
if the gain value has been previously set, retrieving the stored setting value from a non-volatile memory and configuring the setting value as the gain value of the sound output amplifier.
